(19) United States
(12) Patent Application Publication
(10) Pub. No.: US 2008/0299248 A1
(43) Pub. Date: Dec. 4, 2008

(54) Plastics injection molding machine

(75) Inventors: Maurizio Bazzo, Oderzo (IT); Marco Salvador, Montebelluna (IT)

Correspondence Address: DAVIDSON BERQUIST JACKSON & GOWDEY LLP, 4300 WILSON BLVD., 7TH FLOOR, ARLINGTON, VA, 22203, US

(73) Assignee: INGLASS S.P.A., San Polo Di Piave (IT)

(21) Appl. No.: 12/153,184

(22) Filed: May 14, 2008

(30) Foreign Application Priority Data
May 15, 2007 (IT) TO2007A 000339

(51) Int. Cl. B29C 45/00

(52) U.S. Cl. 425/589

(57) ABSTRACT

A plastics injection molding machine having a mold comprising at least two metal shells which are brought into contact with each other and are designed to form a closed cavity negatively reproducing the shape of the plastic part for molding, and a plastic material feed line which is supplied with and liquefies a stream of granular plastic material, and which feeds the liquid plastic material in controlled manner to the cavity formed when the two metal shells are mated; the machine also having a detergent mixture feed circuit which, on command, feeds a given quantity of a detergent mixture into the plastic material feed line, and an electronic central control unit for controlling the detergent mixture feed circuit.

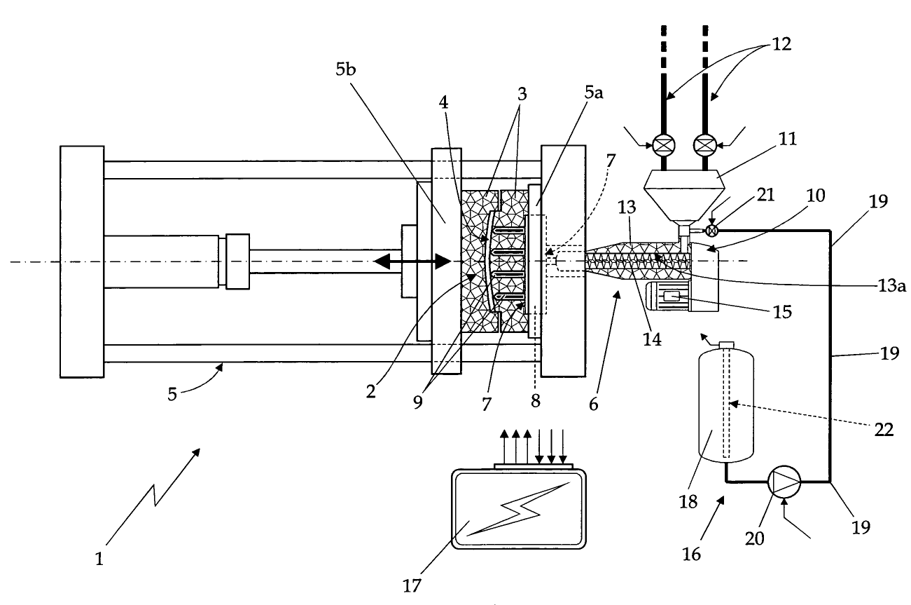

The present invention relates to a plastics injection molding machine.

### BACKGROUND OF THE INVENTION

As is known, most plastics injection molding machines normally comprise a mold comprising at least two metal shells, which are brought into contact with each other to define, at the centre of the contact surface of the shells, a closed cavity shaped to negatively reproduce the shape of the plastic part for molding; a press for bringing the two metal shells of the mold cyclically into contact with each other to cyclically form the cavity negatively reproducing the shape of the part for molding; and a liquid plastic injection device, known as a “hot-channel device”, which feeds the liquid plastic in controlled manner to the cavity formed in the centre of the mold when the two metal shells are mated.

More specifically, the two metal shells of the mold are fixed, facing each other, to the fixed platen and movable platen of the press respectively; and the hot-channel device is housed inside a seat formed in the metal shell fixed rigidly to the fixed platen of the press, on the opposite side to the surface contacting the other metal shell of the mold.

More specifically, the hot-channel device substantially comprises a hollow metal body, known as a “hot chamber”, which is filled continuously with liquid plastic; a number of injectors branching off from the “hot chamber” up to the cavity on the other side of the metal shell, and for regulating outflow of the liquid plastic to the cavity in the centre of the two metal shells; and a number of electric heating units appropriately arranged along the hot-channel device casing formed by the “hot chamber” and injectors, so as to Joule-heat the plastic inside the whole of the hot-channel device.

In other words, the hot-channel device casing as a whole is divided into a number of independent electrically heated sections, each housing and heated by an electric heating unit to keep the plastic material inside the hot-channel device in a liquid or semisolid, highly viscous state at all times.

Known plastics injection molding machines also comprise a plasticizing unit, which is fed with a more or less continuous stream of granular plastic material, which it liquefies to feed a continuous stream of liquid or semisolid plastic directly to the hot-channel device at a predetermined pressure.

More specifically, the plasticizing unit substantially comprises a plastic material hopper, into which the granular plastic material is unloaded by a pneumatic conveyor; and a cylindrical plasticizing chamber formed inside a metal casing housing a number of electric heating units for keeping the casing at a temperature ranging between 200° C. and 300° C. The plasticizing chamber has a first end connected to the bottom of the plastic material hopper to receive the granular plastic material by gravity, and a second end communicating directly with the input of the hot-channel device; and the plasticizing unit comprises a mixing screw mounted for rotation inside the plasticizing chamber and designed to break up, mix, and blend the granular plastic material to assist melting. As it rotates about its longitudinal axis, the mixing screw is also designed to push the by now liquid plastic material to the hot-channel device at a predetermined pressure.

Plastics injection molding machines of the above type operate perfectly with practically all types of plastic material, but pose serious problems when it comes to changing the colour of the plastic from which the parts are made.

In which case, the operator must first expel the plastic material from the hot-channel device and the plasticizing unit, and then remove any scale left inside, to prevent any remains of the previous plastic material from contaminating the new; all of which obviously involves a good deal of downtime.

More specifically, after expelling the plastic material from the machine, the operator must prepare and pour manually into the hopper a detergent mixture which is abrasive and/or capable of considerably reducing the viscosity of the plastic material, and, as it flows through the plasticizing unit and hot-channel device, removing any plastic scale from inside the two devices.

Preparing and pouring the detergent mixture into the machine are unpopular jobs, by very often involving handling and accurately metering toxic, contaminating chemicals, with all the drawbacks this entails.

Moreover, correct metering of the detergent mixture is a delicate operation that calls for a high degree of skill. In fact, if the detergent mixture is not metered correctly, all the parts produced in the molding cycles immediately following changeover of the plastic material present numerous colour defects, and must be rejected.

Since contamination of the plastic material takes hundreds of molding cycles to eliminate, plastic material colour changes greatly increase molding cost, on account of the large number of rejects produced.

To eliminate this drawback, some firms prefer to avoid colour changes, by devoting each machine to the manufacture of parts of one colour; a practice which also obviously increases production costs.

### SUMMARY OF THE INVENTION

It is an object of the present invention to provide a plastics injection molding machine designed to eliminate the aforementioned drawbacks.

According to the present invention, there is provided a plastics injection molding machine as claimed in the attached Claims.

### BRIEF DESCRIPTION OF THE DRAWING

The present invention will now be described with reference to the attached drawing showing a schematic non-limiting embodiment.

### DETAILED DESCRIPTION OF THE INVENTION

Number 1 in the attached drawing indicates as a whole a plastics injection molding machine preferably, though not necessarily, of horizontal extending type.

Machine 1 substantially comprises a mold 2 comprising at least two preferably, though not necessarily, parallelepiped-shaped metal shells 3, which are brought into contact with each other and designed to form, at the centre of the contact surface between the shells, a closed cavity 4 negatively reproducing the shape of the plastic part for molding; a press 5 for moving and supporting the two metal shells 3, and designed, on command, to bring metal shells 3 into contact with each other to form cavity 4 cyclically; and a plastic material feed line 6, which is supplied with and liquefies a more or less continuous stream of granular plastic material, and feeds the liquid plastic material in controlled manner to cavity 4 formed at the centre of mold 2 when the two metal shells 3 are mated.

More specifically, the two metal shells 3 are fixed, facing each other, to the fixed platen 5a and movable platen 5b of press 5 respectively; and plastic material feed line 6 comprises a liquid plastic injection device 7, known as a “hot-channel device”, which is supplied with a continuous stream of liquid plastic material, and feeds the liquid plastic material in controlled manner to cavity 4 formed in the centre of mold 2 when the two metal shells 3 are mated. More specifically, with reference to the attached drawing, plastic injection device 7 is housed inside a seat formed in the metal shell 3 fixed rigidly to the fixed platen 5a of press 5, on the opposite side to the surface contacting the other metal shell 3 of mold 2 (i.e. on the opposite side to cavity 4 formed at the centre of mold 2 when the two metal shells 3 are mated), and substantially comprises a hollow metal body 8, known as a “hot chamber”, which is filled continuously with liquid plastic; and a number of injectors 9 branching off from hollow metal body 8 up to cavity 4 on the other side of metal shell 3, and which open and close, on command, to regulate outflow of the liquid plastic to cavity 4 in the centre of mold 2 defined by metal shells 3.

Plastic injection device 7 also comprises a number of electric heating units (not shown) appropriately arranged along the casing of plastic injection device 7 formed by hollow metal body 8 and injectors 9, so as to Joule-heat the plastic inside the whole of plastic injection device 7.

In other words, the casing of plastic injection device 7 as a whole is divided into a number of independent electrically heated sections, each housing and heated by an electric heating unit to keep the plastic material inside plastic injection device 7 in a liquid or semisolid, highly viscous state at all times.

Mold 2, press 5, and plastic injection device 7 are commonly used parts in the industry, and therefore not described in detail.

With reference to the attached drawing, plastic material feed line 6 also comprises a plasticizing unit 10, which is fed with a more or less continuous stream of granular plastic material, which it liquefies to feed a continuous stream of liquid or semisolid plastic directly to plastic injection device 7 at a predetermined pressure.

More specifically, plasticizing unit 10 substantially comprises a plastic material hopper 11, into which the granular plastic material is unloaded preferably, though not necessarily, by a known pneumatic conveyor 12; a hollow metal casing 13, in which is formed a preferably, though not necessarily, cylindrical plasticizing chamber 13a which has a first end communicating with the bottom of hopper 11 to receive the granular plastic material by gravity, and a second end communicating directly with the input of plastic injection device 7; and a number of electric heating units (not shown) appropriately arranged inside hollow metal casing 13 to Joule-heat and liquefy the granular plastic material fed into plasticizing chamber 13a.

More specifically, the electric heating units inside hollow metal casing 13 keep the area of hollow metal casing 13 surrounding plasticizing chamber 13a at a temperature normally ranging between 200° C. and 300° C., and at any rate higher than the liquefying temperature of the plastic material, so as to liquefy the granular plastic material fed into plasticizing chamber 13a, and then keep the plastic material in the liquid or semisolid, highly viscous state pending transfer to plastic injection device 7.

With reference to the attached drawing, plasticizing unit 10 also comprises a mixing screw 14 mounted for rotation about its longitudinal axis, inside plasticizing chamber 13a, and designed to break up, mix, and blend the granular plastic material inside plasticizing chamber 13a to assist melting; and an electric or hydraulic motor 15 connected mechanically to mixing screw 14 to rotate mixing screw 14 about its longitudinal axis.

As it rotates about its longitudinal axis, mixing screw 14 is also designed to push the by now liquid plastic material to the second end of plasticizing chamber 13a, from where the liquid plastic material flows into plastic injection device 7.

Unlike known plastics injection molding machines, machine 1 also comprises an electronically controlled detergent mixture feed circuit 16 which, on command, feeds into plasticizing chamber 13a of plasticizing unit 10, and/or only into plastic injection device 7, a given quantity of a detergent mixture which is abrasive and/or capable of greatly reducing the viscosity of the plastic material; and an electronic central control unit which, when changing the type of plastic material used to produce the plastic parts, controls feed circuit 16 to fully automatically inject a given quantity of detergent mixture into plasticizing unit 10, and/or into plastic injection device 7, and to accurately meter the amount of mixture actually injected.

More specifically, in the example shown, the electronic central control unit controlling feed circuit 16 is defined by the electronic central control unit 17 of the machine normally used to control injectors 9 of plastic injection device 7, and optionally for also continuously adjusting electric power supply to each of the heating units (not shown) of plastic injection device 7 and plasticizing unit 10.

The detergent mixture is a commonly used chemical in the industry, and therefore not described in detail.

With reference to the attached drawing, detergent mixture feed circuit 16 comprises a storage tank 18 containing the detergent mixture ready for use; a connecting pipe 19 connecting storage tank 18 to plasticizing unit 10, immediately downstream from plastic material hopper 11; a circulating pump 20 for pumping the detergent mixture along pipe 19 from tank 18 to plasticizing unit 10; and an electrically operated on/off valve 21 located along connecting pipe 19 to regulate outflow of the detergent mixture to plasticizing unit 10.

More specifically, in the example shown, pipe 19 connects the bottom of storage tank 18 to the conduit connecting plasticizing chamber 13a of plasticizing unit 10 to plastic material hopper 11, and on/off valve 21 is located at the end of connecting pipe 19, immediately upstream from the conduit connecting plasticizing chamber 13a of plasticizing unit 10 to plastic material hopper 11.

Detergent mixture feed circuit 16 preferably, though not necessarily, also comprises a level sensor 22 for detecting and communicating the detergent mixture level in storage tank 18 to electronic central control unit 17, so this can determine the amount of detergent mixture inside storage tank 18, and amount of detergent mixture fed instant by instant into plasticizing chamber 13a of plasticizing unit 10.

Operation of plastics injection molding machine 1 is easily inferable from the above description, with no further explanation required.

As regards electronically controlled detergent mixture feed circuit 16, on the other hand, this provides for injecting the precise quantity of detergent mixture fully automatically, with no need for or supervision by skilled personnel.

Electronically controlled detergent mixture feed circuit 16 obviously has numerous advantages.

Being injected fully automatically, the detergent mixture is metered much more accurately and exactly at the right time when changing the plastic material, with no direct, skilled manual intervention required.

Clearly, changes may be made to plastics injection molding machine 1 without, however, departing from the scope of the present invention.

For example, detergent mixture supply pipe 19 may connect the bottom of storage tank 18 to the conduit connecting plasticizing chamber 13a of plasticizing unit 10 to plastic injection device 7, so as to inject the detergent mixture into plasticizing unit 10 downstream from plasticizing chamber 13a. Alternatively, detergent mixture supply pipe 19 may even connect the bottom of storage tank 18 directly to plasticizing chamber 13a of plasticizing unit 10, so as to inject the detergent mixture directly into plasticizing chamber 13a of plasticizing unit 10.

Detergent mixture supply pipe 19 may obviously even be connected to plastic material feed line 6, directly to plastic injection device 7, downstream from plasticizing unit 10.

1) A plastics injection molding machine (1) having a mold (2) comprising at least two metal shells (3) which are brought into contact with each other and are designed to form a closed cavity (4) negatively reproducing the shape of the plastic part for molding, and a plastic material feed line (6) which is supplied with and liquefies a stream of granular plastic material, and feeds said liquid plastic material in controlled manner to the cavity (4) formed when said metal shells (3) are mated; said machine (1) being characterized by also comprising a detergent mixture feed circuit (16) which, on command, feeds a given quantity of a detergent mixture into said plastic material feed line (6), and an electronic central control unit (17) for controlling said detergent mixture feed circuit (16).

2) A machine as claimed in claim 1, characterized in that said detergent mixture feed circuit (16) comprises a storage tank (18) containing detergent mixture ready for use, a connecting pipe (19) connecting the storage tank (18) to the plastic material feed line (6), and pumping means (20, 21) for selectively pumping said given quantity of detergent mixture along the connecting pipe (19), from the storage tank (18) to the plastic material feed line (6).

3) A machine as claimed in claim 2, characterized in that said plastic material feed line (6) comprises a liquid plastic material injection device (7) which feeds the liquid plastic material in controlled manner to the cavity (4) formed at the centre of the mold (2) when said metal shells (3) are mated, and a plasticizing unit (10) which is supplied with and liquefies a stream of granular plastic material, and feeds a continuous stream of liquid plastic material directly to said plastic material injection device (7).

4) A machine as claimed in claim 3, characterized in that said plasticizing unit (10) comprises a hollow metal casing (13) in which is formed a plasticizing chamber (13a) having a first end communicating directly with the input of said plastic material injection device (7); a number of electric heating units appropriately arranged inside said hollow metal casing (13), and which Joule-heat, to liquefy, the granular plastic material fed into the plasticizing chamber (13a); and a mixing screw (14) mounted for rotation inside the plasticizing chamber (13a) to break up, mix, and blend the plastic material inside the plasticizing chamber (13a), and to push the by now liquid plastic material to the first end of the plasticizing chamber (13a), from where said liquid plastic material flows to the plastic material injection device (7).

5) A machine as claimed in claim 4, characterized in that said plasticizing unit (10) also comprises a plastic material hopper (11) into which the granular plastic material is fed; said hopper (11) being connected to a second end of said plasticizing chamber (13a) to receive the granular plastic material by gravity.

6) A machine as claimed in claim 4, characterized in that said connecting pipe (19) is connected to said plasticizing unit (10) upstream from, downstream from, or at said plasticizing chamber (13a).

7) A machine as claimed in claim 3, characterized in that said connecting pipe (19) is connected to said plastic material injection device (7) downstream from said plasticizing unit (10).

8) A machine as claimed in claim 2, characterized in that said detergent mixture feed circuit (16) also comprises measuring means (17, 22) for determining the quantity of detergent mixture fed to said plastic material feed line (6).

9) A machine as claimed in claim 3, characterized in that said plastic material injection device (7) comprises a hollow metal body (8) which is filled continuously with liquid plastic material; at least one injector (9) which branches off from the hollow metal body (8) up to the cavity (4) located on the other side of the metal shell (3), and is designed to open and close, on command, to regulate outflow of the liquid plastic material to said cavity (4); and a number of electric heating units appropriately arranged along the casing of said plastic material injection device (7) to Joule-heat the plastic material inside the plastic material injection device.

10) A machine as claimed in claim 4, characterized in that said electronic central control unit (17) also controls said at least one injector (9) of said plastic material injection device (7), and/or regulates electric power supply to each of the heating units in said plastic material injection device (7) and/or in said plasticizing unit (10).
